(19) United States
(12) Patent Application Publication
(10) Pub. No.: US 2016/0301530 A1
(43) Pub. Date: Oct. 13, 2016

(54) SENSITIVE OPERATION VERIFICATION METHOD, APPARATUS, AND SYSTEM

(71) Applicant: TENCENT TECHNOLOGY (SHENZHEN) COMPANY LIMITED, SHENZHEN (CN)

(72) Inventor: Xiao He, Shenzhen (CN)

(21) Appl. No.: 15/184,596

(22) Filed: Jun. 16, 2016

Related U.S. Application Data
(63) Continuation of application No. PCT/CN2015/075105, filed on Mar. 26, 2015.

(30) Foreign Application Priority Data
Mar. 26, 2014 (CN) 201410115061.2

(51) Int. Cl. H04L 9/32; G06K 7/10; H04L 29/06

(52) U.S. Cl. CPC H04L 9/32; H04L 63/0428; G06K 7/10722

(57) ABSTRACT

The present disclosure discloses a sensitive operation verification method, apparatus, and system, and belongs to the field of network security. The method includes: acquiring encrypted verification information on an operating terminal; decrypting the encrypted verification information according to decryption information corresponding to a user account to obtain verification information; receiving a result of verification that is performed on the sensitive operation by a user according to the verification information; encrypting the verification result according to encryption information corresponding to the user account to obtain an encrypted verification result; and providing the encrypted verification result to the operating terminal, so that the operating terminal feeds back the encrypted verification result to the server, and after the server detects that the encrypted verification result is that the verification succeeds, the server authorizes the operating terminal to execute the sensitive operation.

### CROSS REFERENCE TO RELATED APPLICATIONS

This is a continuation application of International Patent Application No: PCT/CN2015/075105, filed on Mar. 26, 2015, which claims priority to Chinese Patent Application No.: 201410115061.2, filed on Mar. 26, 2014, the contents of which are incorporated by reference herein in their entirety for all intended purposes.

### FIELD OF THE TECHNOLOGY

Embodiments of the present invention relates to the field of network security, and in particular, to a sensitive operation verification method, apparatus, and system.

### BACKGROUND OF THE DISCLOSURE

At present, Internet services are diversified, many of them involve property and privacy, and some lawless persons attempt to steal others' passwords to intrude into accounts, steal property, eavesdrop on privacy, and the like. To prevent these malicious behaviors, a sensitive operation verification mechanism needs to be introduced.

A common sensitive operation verification method roughly has a process as follows: A user applies on a computer (also referred to as an operating terminal) to a server for a sensitive operation. The server displays a verification interface on the computer, and further sends a 6-digit dynamic password to a mobile phone (also referred to as an auxiliary terminal) bound to the user. Then, the user inputs the 6-digit dynamic password received on the mobile phone to the verification interface displayed on the computer, and the password is submitted to the server. When the server detects that the 6-digit dynamic password is correct, the server authorizes to the computer to execute the sensitive operation.

In the foregoing sensitive operation verification method, the auxiliary terminal needs to communicate with the server to receive the dynamic password sent by the server; as a result, in a region with a weak signal, if the auxiliary terminal cannot communicate with the server, the auxiliary terminal cannot receive the verification password, and cannot complete verification on the sensitive operation.

### SUMMARY

Embodiments of the present invention provide a sensitive operation verification method, apparatus, and system. The technical solutions are as follows:

According to a first aspect, a sensitive operation verification method is provided, applied to an auxiliary terminal, where the method includes:

acquiring encrypted verification information on an operating terminal, the encrypted verification information being information that is encrypted and used for verifying a sensitive operation of a user account, which is fed back by a server to the operating terminal after the operating terminal applies to the server for the sensitive operation;

decrypting the encrypted verification information according to decryption information corresponding to the user account to obtain verification information;

receiving a result of verification that is performed on the sensitive operation by a user according to the verification information;

encrypting the verification result according to encryption information corresponding to the user account to obtain an encrypted verification result; and

providing the encrypted verification result to the operating terminal, so that the operating terminal feeds back the encrypted verification result to the server, and after the server detects that the encrypted verification result is that the verification succeeds, the server authorizes the operating terminal to execute the sensitive operation.

According to a second aspect, a sensitive operation verification method is provided, applied to an operating terminal, where the method includes:

applying to a server for a sensitive operation of a user account;

receiving encrypted verification information fed back by the server and used for verifying the sensitive operation;

providing the encrypted verification information to an auxiliary terminal, so that the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain an encrypted verification result, and provides the encrypted verification result to the operating terminal;

acquiring the encrypted verification result provided by the auxiliary terminal; and

feeding back the encrypted verification result to the server, so that after the server detects that the encrypted verification result is that the verification succeeds, the server authorizes the operating terminal to execute the sensitive operation.

According to a third aspect, a sensitive operation verification method is provided, applied to a server, where the method includes:

receiving a sensitive operation, which an operating terminal applies for, of a user account;

generating encrypted verification information used for verifying the sensitive operation;

feeding back the encrypted verification information used for verifying the sensitive operation to the operating terminal;

receiving an encrypted verification result fed back by the operating terminal, the encrypted verification result being fed back by the operating terminal to the server after the operating terminal provides the encrypted verification information to an auxiliary terminal, and after the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain the encrypted verification result, and provides the encrypted verification result to the operating terminal; and

authorizing, after detecting that the encrypted verification result is that the verification succeeds, the operating terminal to execute the sensitive operation.

According to a fourth aspect, a sensitive operation verification apparatus is provided, applied to an auxiliary terminal, where the apparatus includes:

an information acquiring module, configured to acquire encrypted verification information on an operating terminal, the encrypted verification information being information that is encrypted and used for verifying a sensitive operation of a user account, which is fed back by a server to the operating terminal after the operating terminal applies to the server for the sensitive operation;

an information decrypting module, configured to decrypt the encrypted verification information according to decryption information corresponding to the user account to obtain verification information;

a first receiving module, configured to receive a result of verification that is performed on the sensitive operation by a user according to the verification information;

a result encrypting module, configured to encrypt the verification result according to encryption information corresponding to the user account to obtain an encrypted verification result; and

a result providing module, configured to provide the encrypted verification result to the operating terminal, so that the operating terminal feeds back the encrypted verification result to the server, and after the server detects that the encrypted verification result is that the verification succeeds, the server authorizes the operating terminal to execute the sensitive operation.

According to a fifth aspect, a sensitive operation verification apparatus is provided, applied to an operating terminal, where the apparatus includes:

a module for applying for an operation, configured to apply to a server for a sensitive operation of a user account;

an information receiving module, configured to receive encrypted verification information fed back by the server and used for verifying the sensitive operation;

an information providing module, configured to provide the encrypted verification information to an auxiliary terminal, so that the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain an encrypted verification result, and provides the encrypted verification result to the operating terminal;

a result acquiring module, configured to acquire the encrypted verification result provided by the auxiliary terminal; and

a result feedback module, configured to feed back the encrypted verification result to the server, so that after the server detects that the encrypted verification result is that the verification succeeds, the server authorizes the operating terminal to execute the sensitive operation.

According to a sixth aspect, a sensitive operation verification apparatus is provided, applied to a server, where the apparatus includes:

an operation receiving module, configured to receive a sensitive operation, which an operating terminal applies for, of a user account;

an information generating module, configured to generate encrypted verification information used for verifying the sensitive operation;

an information feedback module, configured to feed back the encrypted verification information used for verifying the sensitive operation to the operating terminal;

a second receiving module, configured to receive an encrypted verification result fed back by the operating terminal, the encrypted verification result being fed back by the operating terminal to the server after the operating terminal provides the encrypted verification information to an auxiliary terminal, and after the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain the encrypted verification result, and provides the encrypted verification result to the operating terminal; and

an operation authorizing module, configured to: after it is detected that the encrypted verification result is that the verification succeeds, authorize the operating terminal to execute the sensitive operation.

According to a seventh aspect, a sensitive operation verification system is provided, including:

the auxiliary terminal includes the sensitive operation verification apparatus according to the fourth aspect;

the auxiliary terminal includes the sensitive operation verification apparatus according to the fifth aspect; and

the server includes the sensitive operation verification apparatus according to the sixth aspect.

By acquiring encrypted verification information on an operating terminal;
decrypting the encrypted verification information according to decryption information corresponding to a user account to obtain verification information; receiving a result of verification that is performed on the sensitive operation by a user according to the verification information; encrypting the verification result according to encryption information corresponding to the user account to obtain an encrypted verification result; and providing the encrypted verification result to the operating terminal, so that the operating terminal feeds back the encrypted verification result to the server, and after the server detects that the encrypted verification result is that the verification succeeds, the server authorizes the operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

### BRIEF DESCRIPTION OF THE DRAWINGS

To describe the technical solutions of the embodiments of the present invention more clearly, the accompanying drawings for illustrating the embodiments are introduced briefly in the following. Apparently, the drawings in the following description are only some embodiments of the present invention, and a person skilled in the art may derive other drawings based on these accompanying drawings without creative efforts.

FIG. 1 is an exemplary schematic structural diagram of an implementation environment involved by a sensitive operation verification method according to embodiments of the present invention;

FIG. 2 is a method flowchart of a sensitive operation verification method according to an embodiment of the present invention;

FIG. 3 is a method flowchart of a sensitive operation verification method according to another embodiment of the present invention;

FIG. 4 is a method flowchart of a sensitive operation verification method according to still another embodiment of the present invention;

FIG. 5A is a method flowchart of a sensitive operation verification method according to yet another embodiment of the present invention;

FIG. 5B is a method flowchart of a sensitive operation verification method according to still yet another embodiment of the present invention;

FIG. 5C is a schematic diagram of payment operation verification according to a still yet further another embodiment of the present invention;

FIG. 6 is a block diagram of the structure of a sensitive operation verification apparatus according to an embodiment of the present invention;

FIG. 7 is a block diagram of the structure of a sensitive operation verification apparatus according to another embodiment of the present invention;

FIG. 8 is a block diagram of the structure of a sensitive operation verification apparatus according to still another embodiment of the present invention;

FIG. 9 is a block diagram of the structure of a sensitive operation verification system according to an embodiment of the present invention;

FIG. 10 is a schematic structural diagram of a server according to an embodiment of the present invention; and

FIG. 11 is a schematic structural diagram of a terminal according to an embodiment of the present invention.

### DESCRIPTION OF EMBODIMENTS

To make the objectives, technical solutions, and advantages of the present disclosure clearer, the following further describes in detail the embodiments of the present invention with reference to the accompanying drawings.

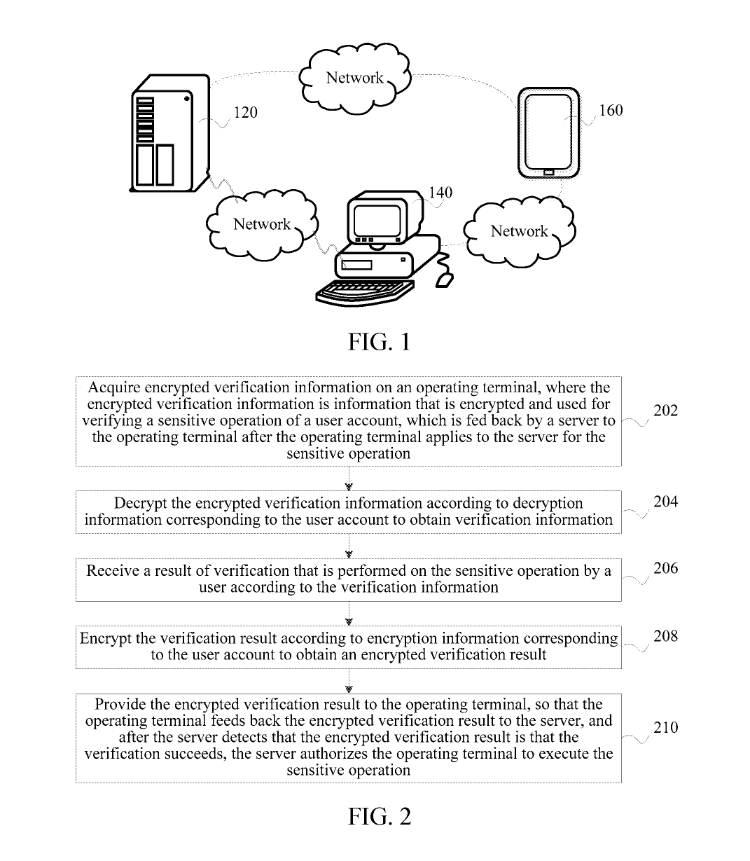

Referring to FIG. 1, FIG. 1 is a schematic structural diagram of an implementation environment involved by a sensitive operation verification method according to embodiments of the present invention. The implementation environment includes: a server 120, an operating terminal 140, and an auxiliary terminal 160.

The server 120 may be one server, or a server cluster including a plurality of servers, or a cloud computing service center. During binding to a user account, the server 120 is interconnected with the auxiliary terminal 160 by using a network. During verification on a sensitive operation, the server 120 is interconnected with the operating terminal 140 by using a network, and in this case, the server 120 may be not in network interconnection with the auxiliary terminal 160, and may also be in network interconnection with the auxiliary terminal 160.

The operating terminal 140 may be an electronic device such as a tablet computer, a desktop computer, a notebook computer, or an intelligent household appliance. The operating terminal 140 is capable of receiving information sent by the server 120, acquiring information on the auxiliary terminal 160, and transmitting information, and may also be capable of displaying information such as an image and a text, and playing information such as audio. The operating terminal 140 has at least one of a camera, Bluetooth, a data transmission interface, a microphone, and a light sensing component. The operating terminal 140 is interconnected with the server 120 by using a network. The operating terminal 140 may not be in network interconnection with the auxiliary terminal 160, and may also be in network interconnection with the auxiliary terminal 160.

The auxiliary terminal 160 may be an electronic device such as a smart phone, a tablet computer, an ebook reader, or a wearable device. An application for verifying a sensitive operation is installed on the auxiliary terminal 160. The auxiliary terminal 160 has at least one of a camera, Bluetooth, a data transmission interface, a microphone, and a light sensing component. During binding to a user account, the auxiliary terminal 160 is in network interconnection with the server 120. During information verification, the auxiliary terminal 160 may be in network interconnection with the operating terminal 140, may also not be in network interconnection with the operating terminal 140, and may also not be in network interconnection with the server 120.

Referring to FIG. 2, FIG. 2 is a method flowchart of a sensitive operation verification method according to an embodiment of the present invention. This embodiment is described by using an example in which the sensitive operation verification method is applied to the auxiliary terminal shown in FIG. 1. The sensitive operation verification method includes:

Step 202: Acquire encrypted verification information on an operating terminal, where the encrypted verification information is information that is encrypted and used for verifying a sensitive operation of a user account, which is fed back by a server to the operating terminal after the operating terminal applies to the server for the sensitive operation.

Step 204: Decrypt the encrypted verification information according to decryption information corresponding to the user account to obtain verification information.

Step 206: Receive a result of verification that is performed on the sensitive operation by a user according to the verification information.

Step 208: Encrypt the verification result according to encryption information corresponding to the user account to obtain an encrypted verification result.

Step 210: Provide the encrypted verification result to the operating terminal, so that the operating terminal feeds back the encrypted verification result to the server, and after the server detects that the encrypted verification result is that the verification succeeds, the server authorizes the operating terminal to execute the sensitive operation.

In conclusion, with the sensitive operation verification method provided in this embodiment, by acquiring encrypted verification information on an operating terminal; decrypting the encrypted verification information according to decryption information corresponding to a user account to obtain verification information; receiving a result of verification that is performed on the sensitive operation by a user according to the verification information; encrypting the verification result according to encryption information corresponding to the user account to obtain an encrypted verification result; and providing the encrypted verification result to the operating terminal, so that the operating terminal feeds back the encrypted verification result to the server, and after the server detects that the encrypted verification result is that the verification succeeds, the server authorizes the operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

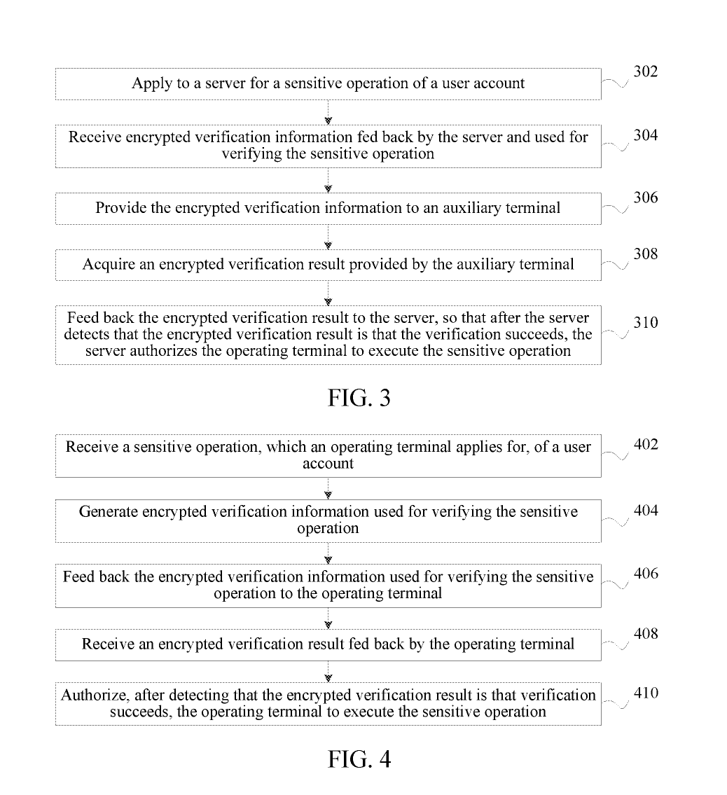

Referring to FIG. 3, FIG. 3 is a method flowchart of a sensitive operation verification method according to an embodiment of the present invention. This embodiment is described by using an example in which the sensitive operation verification method is applied to the operating terminal shown in FIG. 1. The sensitive operation verification method includes:

Step 302: Apply to a server for a sensitive operation of a user account.

Step 304: Receive encrypted verification information fed back by the server and used for verifying the sensitive operation.

Step 306: Provide the encrypted verification information to an auxiliary terminal,

so that the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain an encrypted verification result, and provides the encrypted verification result to the operating terminal.

Step 308: Acquire the encrypted verification result provided by the auxiliary terminal.

Step 310: Feed back the encrypted verification result to the server, so that after the server detects that the encrypted verification result is that the verification succeeds, the server authorizes the operating terminal to execute the sensitive operation.

In conclusion, with the sensitive operation verification method provided in this embodiment, by applying to a server for a sensitive operation of a user account; receiving encrypted verification information fed back by the server and used for verifying the sensitive operation; providing the encrypted verification information to an auxiliary terminal; acquiring an encrypted verification result provided by the auxiliary terminal; and feeding back the encrypted verification result to the server, so that after the server detects that the encrypted verification result is that the verification succeeds, the server authorizes an operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

Referring to FIG. 4, FIG. 4 is a method flowchart of a sensitive operation verification method according to an embodiment of the present invention. This embodiment is described by using an example in which the sensitive operation verification method is applied to the server shown in FIG. 1. The sensitive operation verification method includes:

Step 402: Receive a sensitive operation, which an operating terminal applies for, of a user account.

Step 404: Generate encrypted verification information used for verifying the sensitive operation.

Step 406: Feed back the encrypted verification information used for verifying the sensitive operation to the operating terminal.

Step 408: Receive an encrypted verification result fed back by the operating terminal, where

the encrypted verification result is fed back by the operating terminal to the server after the operating terminal provides the encrypted verification information to an auxiliary terminal, and after the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain the encrypted verification result, and provides the encrypted verification result to the operating terminal.

Step 410: Authorize, after detecting that the encrypted verification result is that the verification succeeds, the operating terminal to execute the sensitive operation.

In conclusion, with the sensitive operation verification method provided in this embodiment, by receiving a sensitive operation, which an operating terminal applies for, of a user account; generating encrypted verification information used for verifying the sensitive operation; feeding back the encrypted verification information used for verifying the sensitive operation to the operating terminal; receiving an encrypted verification result fed back by the operating terminal; and authorizing, after detecting that the encrypted verification result is that the verification succeeds, the operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

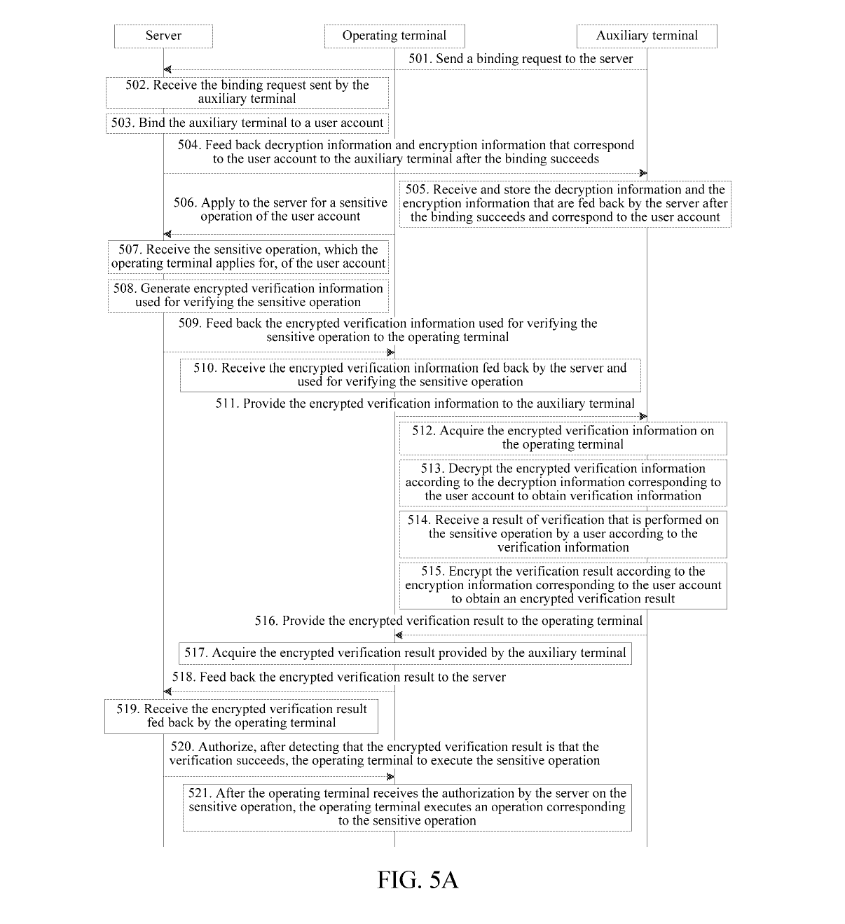

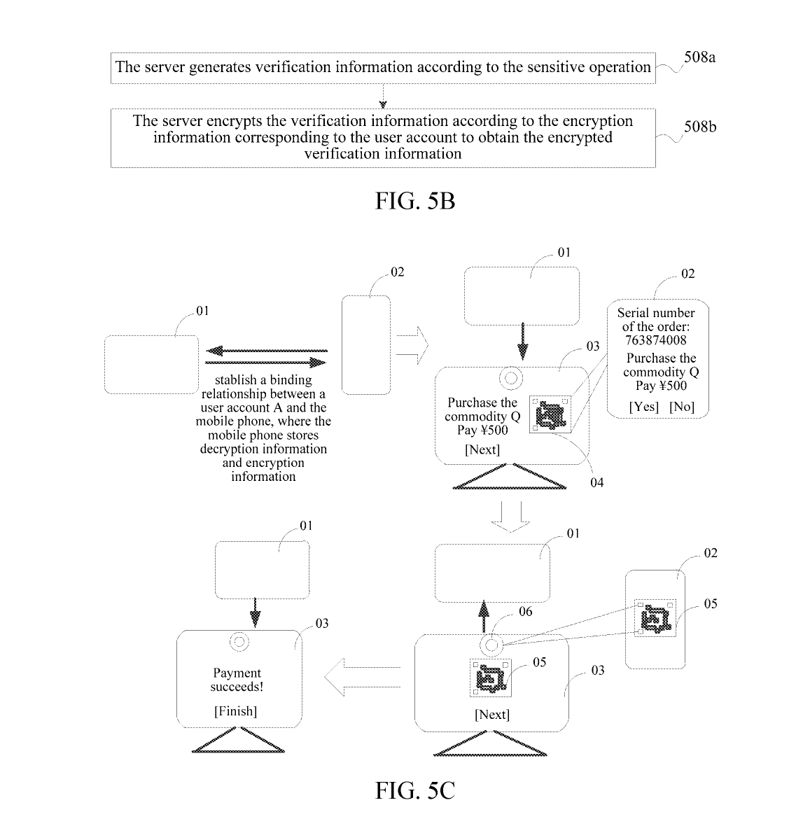

Referring to FIG. 5A, FIG. 5A is a method flowchart of a sensitive operation verification method according to an embodiment of the present invention. This embodiment is described by using an example in which the sensitive operation verification method is applied to the implementation environment shown in FIG. 1. The sensitive operation verification method includes:

Step 501: An auxiliary terminal sends a binding request to a server.

The binding request is used for requesting binding to a user account. An application related to the user account may be installed on the auxiliary terminal in advance. For example, if the user account is a chat account, a chat application may be installed on the auxiliary terminal; if the user account is a transaction account, a transaction application may be installed on the auxiliary terminal.

In addition, when the auxiliary terminal sends the binding request to the server, the auxiliary terminal may also simultaneously send a hardware capability configuration of the auxiliary terminal to the server. That is, the hardware capability configuration of the auxiliary terminal is carried in the binding request. The hardware capability configuration includes at least one of a camera, a microphone, a data line interface, a Bluetooth module, a WIFI (Wireless Fidelity) module, and a light sensing component. Certainly, the auxiliary terminal may also separately send the hardware capability configuration of the auxiliary terminal to the server. Correspondingly, the server receives the hardware capability configuration of the auxiliary terminal sent by the auxiliary terminal.

Step 502: The server receives the binding request sent by the auxiliary terminal.

Step 503: The server binds the auxiliary terminal to a user account.

If the binding request further carries the hardware capability configuration of the auxiliary terminal, the server also stores the hardware capability configuration of the auxiliary terminal together with the binding relationship.

Step 504: The server feeds back decryption information and encryption information that correspond to the user account to the auxiliary terminal after the binding succeeds.

Decryption information and encryption information that correspond to a user account can be uniquely used for encrypting or decrypting information related to the user account corresponding to the decryption information and the encryption information.

Step 505: The server receives and stores the decryption information and the encryption information that are fed back by the server after the binding succeeds and correspond to the user account,

so that when the auxiliary terminal acquires information related to the user account, the auxiliary terminal can encrypt or decrypt the information related to the user account by using the decryption information and the encryption information.

After the auxiliary terminal is bound to the user account, and stores the decryption information and the encryption information that correspond to the user account, the auxiliary terminal may verify the information related to the user account.

It is supplemented that, in the foregoing step 501 to step 505, the auxiliary terminal is in network interconnection with the server; in the following step 506 to step 521, an operating terminal is in network interconnection with the server, the auxiliary terminal may not be in network interconnection with the server, and the auxiliary terminal also may not be in network interconnection with the operating terminal.

Step 506: An operating terminal applies to the server for a sensitive operation of the user account.

The sensitive operation refers to an operation on private information related to the user account, for example, transfer of property, view of individual privacy, view of location information, and view of transaction details. To ensure the security of user account information, when a user triggers the sensitive operation, the sensitive operation needs to be verified, and the operating terminal can continue to execute the sensitive operation only after the verification succeeds.

Step 507: The server receives the sensitive operation, which the operating terminal applies for, of the user account.

Step 508: The server generates encrypted verification information used for verifying the sensitive operation.

As shown in FIG. 5B, this step specifically includes the following substeps:

Step 508a: The server generates verification information according to the sensitive operation.

The verification information refers to information corresponding to the sensitive operation. The verification information mainly includes the user account, an identifier of the verification information, and operation content corresponding to the sensitive operation; and the verification information may further include at least one of a random number, time at which the sensitive operation is triggered, time at which the verification information is generated, an IP address of the operating terminal, hardware information of the auxiliary terminal that stores the decryption information and the encryption information of the user account, and risk prompt information. The random number is used for ensuring the uniqueness of the verification information.

For example, if the sensitive operation is to transfer property, the verification information generated by the server may include a user account on which the property transfer occurs, the amount of the property to be transferred, time at which the property transfer operation is triggered, the IP address of the operating terminal, a serial number of a detail record of the property transfer, a random number, information for prompting a risk that may occur on the operation property transfer, and the like.

Step 508b: The server encrypts the verification information according to the encryption information corresponding to the user account to obtain the encrypted verification information.

To ensure the security of the verification information when the verification information is transmitted by using a network or transmitted in other manners, before the server feeds back the verification information to the operating terminal, the verification information needs to be encrypted by using the encryption information corresponding to the user account to obtain the encrypted verification information; in this way, even though the verification information is acquired by another person, the another person still cannot acquire the verification information if the another person does not have the decryption information corresponding to the user account, thereby ensuring the security of verification information transmission.

If the auxiliary terminal has sent the hardware capability configuration of the auxiliary terminal to the server in advance, when the server encrypts the verification information according to the encryption information corresponding to the user account, the server may further generate, according to the hardware capability configuration of the auxiliary terminal, the encrypted verification information in a form supported by hardware of the auxiliary terminal.

For example, if the hardware capability configuration of the auxiliary terminal includes a camera, the server generates the encrypted verification information transmitted in a graphic code form; if the hardware capability configuration of the auxiliary terminal includes a microphone, the server generates the encrypted verification information transmitted in a sound wave form; if the hardware capability configuration of the auxiliary terminal includes a data line or Bluetooth or Infrared, the server generates the encrypted verification information transmitted in a character form; if the hardware capability configuration of the auxiliary terminal includes a light sensing component, the server generates the encrypted verification information transmitted in a light wave form.

When the hardware capability configuration of the auxiliary terminal includes at least two of a camera, a microphone, a data line interface, a Bluetooth module, a WIFI module, and a light sensing component, priorities may be set to the hardware capability configuration, the encrypted verification information in a form supported by hardware with a higher priority is generated preferentially.

Step 509: The server feeds back the encrypted verification information used for verifying the sensitive operation to the operating terminal.

For example, the server may generate a two-dimensional code according to the encrypted verification information, and feed back the two-dimensional code to the operating terminal.

Step 510: The operating terminal receives the encrypted verification information fed back by the server and used for verifying the sensitive operation.

In addition, if the auxiliary terminal has sent the hardware capability configuration of the auxiliary terminal to the server in advance, the server generates, according to the hardware capability configuration of the auxiliary terminal, the encrypted verification information in a form supported by hardware of the auxiliary terminal, and the operating terminal receives the encrypted verification information in the form supported by the hardware of the auxiliary terminal, which is generated by the server according to the hardware capability configuration of the auxiliary terminal.

Step 511: The operating terminal provides the encrypted verification information to the auxiliary terminal.

In this embodiment, to prevent a virus such as a Trojan horse on the operating terminal from stealing the encrypted verification information, the decryption information, the encryption information, and the like, the operating terminal does not store the decryption information and the encryption information that correspond to the user account, nor locally decrypts the encrypted verification information received from the server and used for verifying the sensitive operation. Instead, the operating terminal provides the encrypted verification information to the auxiliary terminal for decryption and verification. In addition, in a region with a weak signal, for example, a region such as a remote mountainous region, a basement, or a high floor, it is possible that the auxiliary terminal cannot acquire the encrypted verification information from the server by using a network, and therefore, the server may send the encrypted verification information to the operating terminal, and the auxiliary terminal acquires the encrypted verification information from the operating terminal.

The manner for the operating terminal to provide the encrypted verification information to the auxiliary terminal includes but is not limited to the following four manners:

1. The operating terminal provides the encrypted verification information in a graphic code form to the auxiliary terminal.

The graphic code may be a two-dimensional code, and may also be another graphic code that can represent an integrated identifier string. If the encrypted verification information is represented in a graphic code form, the graphic code may further be displayed on the operating terminal.

2. The operating terminal provides the encrypted verification information in a sound wave form to the auxiliary terminal.

A sound wave may be any one of an infrasonic wave, an audible wave, an ultrasonic wave, and a hypersonic wave.

2. The operating terminal provides the encrypted verification information in a character form to the auxiliary terminal.

A character may be a normal text, and may also be a special text such as a Mars text, a music note, or a code.

4. The operating terminal provides the encrypted verification information in a light wave form to the auxiliary terminal.

The light wave form may be a form of any one of visible light, ultraviolet light, and infrared light.

In addition, the operating terminal may further simultaneously send a hardware capability configuration of the operating terminal to the auxiliary terminal, that is, send the encrypted verification information together with the hardware capability configuration of the operating terminal to the auxiliary terminal, where the hardware capability configuration includes at least one of a camera, a microphone, a data line interface, a Bluetooth module, a WIFI module, and a light sensing component. Certainly, the operating terminal may also separately send the hardware capability configuration of the operating terminal to the auxiliary terminal. Correspondingly, the auxiliary terminal receives the hardware capability configuration of the operating terminal sent by the operating terminal.

Step 512: The auxiliary terminal acquires the encrypted verification information on the operating terminal.

The encrypted verification information is information that is encrypted and used for verifying the sensitive operation of the user account, which is fed back by the server to the operating terminal after the operating terminal applies to the server for the sensitive operation.

The manner for the auxiliary terminal to acquire the encrypted verification information on the operating terminal includes but is not limited to the following four manners:

1. If the encrypted verification information is in a graphic code form, the auxiliary terminal acquires the encrypted verification information in a graphic code form from the operating terminal by using a camera.

The auxiliary terminal may directly scan a graphic code on the operating terminal by using the camera, to acquire the encrypted verification information.

2. If the encrypted verification information is in a sound wave form, the auxiliary terminal acquires the encrypted verification information in a sound wave form from the operating terminal by using a microphone.

3. If the encrypted verification information is in a character form, the auxiliary terminal acquires the encrypted verification information in a character form from the operating terminal by using a data line or Bluetooth or Infrared or a wireless network.

4. If the encrypted verification information is in a light wave form, the auxiliary terminal acquires the encrypted verification information in a light wave form from the operating terminal by using a light sensing component.

Step 513: The auxiliary terminal decrypts the encrypted verification information according to the decryption information corresponding to the user account to obtain verification information.

Because the decryption information corresponding to the user account is stored on the auxiliary terminal in advance, the auxiliary terminal can decrypt the encrypted verification information by using the decryption information to obtain the verification information.

It should be supplemented that, the auxiliary terminal can store decryption information corresponding to more than one user account, and the auxiliary terminal can find the decryption information corresponding to the user account according to the user account in the encrypted verification information, to decrypt the encrypted verification information. For example, a mobile phone is bound to a user account A, a user account B, and a user account C, and stores decryption information and encryption information of the user account A, the user account B, and the user account C, and when received encrypted verification information is information related to the user account A, the mobile phone decrypts the encrypted verification information by using the decryption information corresponding to the user account A.

Step 514: The auxiliary terminal receives a result of verification that is performed on the sensitive operation by a user according to the verification information.

This step specifically includes the following substeps:

1. The auxiliary terminal displays the verification information.

After the auxiliary terminal displays the verification information, the user can view whether the verification information displayed on the auxiliary terminal and obtained by decrypting the encrypted verification information is consistent with verification information corresponding to the sensitive operation.

2. The auxiliary terminal receives an instruction indicating that the verification succeeds or an instruction indicating that the verification does not succeed, which is triggered by the user after verifying the sensitive operation according to the verification information, and generates a corresponding verification result.

If the verification information viewed by the user and obtained by decrypting the encrypted verification information is consistent with the verification information corresponding to the sensitive operation, the user triggers an instruction indicating that the verification succeeds, and the auxiliary terminal receives the instruction indicating that the verification succeeds, which is triggered by the user after verifying the sensitive operation according to the verification information, and generates a verification result according to the instruction indicating that the verification succeeds. If the verification information viewed by the user and obtained by decrypting the encrypted verification information is inconsistent with the verification information corresponding to the sensitive operation, the user triggers an instruction indicating that the verification does not succeed, and the auxiliary terminal generates a verification result according to the instruction indicating that the verification does not succeed.

Step 515: The auxiliary terminal encrypts the verification result according to the encryption information corresponding to the user account to obtain an encrypted verification result.

Because the encryption information corresponding to the user account is stored on the auxiliary terminal in advance, the auxiliary terminal can encrypt the verification result by using the encryption information to obtain the encrypted verification result.

It should be supplemented that, the auxiliary terminal may store encryption information corresponding to more than one user account, and the auxiliary terminal needs to encrypt the verification result by using the encryption information corresponding to the corresponding user account. For example, if the auxiliary terminal performs decryption by using decryption information corresponding to a user account A, when the auxiliary terminal encrypts the verification result, the auxiliary terminal needs to use encryption information corresponding to the user account A.

In addition, if the operating terminal has sent the hardware capability configuration of the operating terminal to the auxiliary terminal, and the auxiliary terminal has received the hardware capability configuration sent by the operating terminal, the auxiliary terminal can generate, according to the hardware capability configuration of the operating terminal, the encrypted verification result in a form supported by hardware of the operating terminal. This is similar to the manner for the server to generate, according to the hardware capability configuration of the auxiliary terminal, the encrypted verification information in a form supported by hardware of the auxiliary terminal, and details are not described herein again.

Step 516: The auxiliary terminal provides the encrypted verification result to the operating terminal.

In this embodiment, because it is possible that the auxiliary terminal cannot be interconnected with the server by using a network, the auxiliary terminal needs to provide the encrypted verification result to the operating terminal, so that the operating terminal feeds back the encrypted verification result to the server, and after the server detects that the encrypted verification result is that the verification succeeds, the server authorizes the operating terminal to execute the sensitive operation.

The manner for the auxiliary terminal to provide the encrypted verification result to the operating terminal includes but is not limited to the following four manners:

1. The auxiliary terminal provides the encrypted verification result in a graphic code form to the operating terminal.

2. The auxiliary terminal provides the encrypted verification result in a sound wave form to the operating terminal.

3. The auxiliary terminal provides the encrypted verification result in a character form to the operating terminal.

4. The auxiliary terminal provides the encrypted verification result in a light wave form to the operating terminal.

The manner in this step is similar to that in step 511, and details are not described herein again.

Step 517: The operating terminal acquires the encrypted verification result provided by the auxiliary terminal.

The manner for the operating terminal to acquire the encrypted verification result provided by the auxiliary terminal includes but is not limited to the following four manners:

1. If the encrypted verification result is in a graphic code form, the operating terminal acquires the encrypted verification result in a graphic code form from the auxiliary terminal by using a camera.

2. If the encrypted verification result is in a sound wave form, the operating terminal acquires the encrypted verification result in a sound wave form from the auxiliary terminal by using a microphone.

3. If the encrypted verification result is in a character form, the operating terminal acquires the encrypted verification result in a character form from the auxiliary terminal by using a data line or Bluetooth or Infrared or a wireless network.

4. If the encrypted verification result is in a light wave form, the operating terminal acquires the encrypted verification result in a light wave form from the auxiliary terminal by using a light sensing component.

The manner in this step is similar to that in step 512, and details are not described herein again.

Step 518: The operating terminal feeds back the encrypted verification result to the server.

Step 519: The server receives the encrypted verification result fed back by the operating terminal.

Step 520: After the server detects that the encrypted verification result is that the verification succeeds, the server authorizes the operating terminal to execute the sensitive operation.

This step specifically includes the following substeps:

1. The server decrypts the encrypted verification result according to the decryption information corresponding to the user account to obtain the verification result.

2. The server detects whether the verification result is that the verification succeeds.

3. If a result of the detection is that the verification succeeds, the server authorizes the operating terminal to execute the sensitive operation.

If the result of the detection is that the verification does not succeed, the server rejects the sensitive operation of the operating terminal.

Step 521: After the operating terminal receives the authorization by the server on the sensitive operation, the operating terminal executes an operation corresponding to the sensitive operation.

For example, the operating terminal transfers property, confirms order information, pays an order amount, view private information, or modifies or stores the private information.

In conclusion, with the sensitive operation verification method provided in this embodiment, by acquiring encrypted verification information on an operating terminal; decrypting the encrypted verification information according to decryption information corresponding to a user account to obtain verification information; receiving a result of verification that is performed on the sensitive operation by a user according to the verification information; encrypting the verification result according to encryption information corresponding to the user account to obtain an encrypted verification result; and providing the encrypted verification result to the operating terminal, so that the operating terminal feeds back the encrypted verification result to the server, and after the server detects that the encrypted verification result is that the verification succeeds, the server authorizes the operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

In addition, the decryption information and the encryption information that correspond to the user account are stored on the auxiliary terminal, and the auxiliary terminal decrypts the encrypted verification information, thereby ensuring that the encrypted verification information, and the decryption information and the encryption information that correspond to the user account are not stolen by a virus such as a Trojan horse on the operating terminal, and ensuring the security of the information; and the auxiliary terminal does not need to communicate with the server and can acquire the encrypted verification information from the operating terminal, and therefore, the sensitive operation verification method can still be used even in a place with a weak signal such as a remote region or a basement. Moreover, the encrypted verification information and the encrypted verification result can be transmitted by using a graphic code such as a two-dimensional code and a camera, so that the operations are simple and convenient, and the costs are low.

As show in FIG. 5C, in a specific embodiment, it is assumed that the user needs to perform a payment operation, the operating terminal is a computer 03, the auxiliary terminal is a mobile phone 02, the operating terminal is in network interconnection with a server 01, and the computer 03 and the mobile phone 02 both has a camera and a screen; then, the payment operation verification process specifically includes the following steps:

1. Establish a binding relationship between a user account A and the mobile phone 02, where the mobile phone 02 stores decryption information and encryption information of the user account A.

In this step, the mobile phone 02 is interconnected with the server 01 by using a network, and the mobile phone 02 sends a binding request to the server 01; the server 01 receives the binding request sent by the mobile phone 02, binds the mobile phone 02 to the user account A, and feeds back the decryption information and the encryption information that correspond to the user account A to the mobile phone 02; and the mobile phone 02 receives and stores the decryption information and the encryption information that are fed back by the server 01.

2. The server 01 generates a two-dimensional code 04 of encrypted payment information according to a payment operation of the user account A, and displays the two-dimensional code 04 of the encrypted payment information on the computer 03.

The computer 03 applies to the server 01 for the payment operation of the user account A; the server 01 receives the payment operation, which the computer 03 applies for, of the user account A; the server 01 generates payment information according to the payment operation, where the payment information may include a payment account, a payment amount, a serial number of the payment, a random number, commodity information, payment time, risk prompt information, and the like; the server 01 encrypts the payment information according to the encryption information of the user account A to obtain the encrypted payment information and generates the two-dimensional code; and the server 01 feeds back the two-dimensional code 04 of the encrypted payment information to the computer 03. The computer 03 receives the two-dimensional code 04 of the encrypted payment information that is fed back by the server and used for verifying the payment operation.

3. The mobile phone 02 acquires the two-dimensional code 04 of the encrypted payment information and performs decryption to obtain payment information, and displays the payment information on a screen so that the user confirms or rejects the payment operation, and generates a payment result.

The two-dimensional code 04 of the encrypted payment information is displayed on a screen of the computer 03; the mobile phone 02 acquires the two-dimensional code 04 of the encrypted payment information on the computer by using a camera; the mobile phone 02 decrypts the two-dimensional code 04 of the encrypted payment information according to the decryption information of the user account A to obtain the payment information; the mobile phone 02 displays the payment information on the screen of the mobile phone; and the mobile phone 02 receives an instruction indicating that the verification succeeds or instruction indicating that the verification does not succeed, which is triggered by the user after verifying the payment operation according to the payment information, and generates a corresponding payment result.

4. The mobile phone 02 encrypts the payment result, generates a two-dimensional code 05 of an encrypted payment result, and displays the two-dimensional code 05 of the encrypted payment result.

The mobile phone 02 encrypts the payment result according to the encryption information of the user account A to obtain the encrypted payment result, generates the two-dimensional code 05 of the encrypted payment result, and displays the two-dimensional code 05 of the encrypted payment result on the screen of the mobile phone.

5. The computer 03 acquires the two-dimensional code 05 of the encrypted payment result by using a camera 06, and sends the two-dimensional code 05 of the encrypted payment result to the server 01.

The mobile phone 02 provides the two-dimensional code 05 of the encrypted payment result to the computer 03; the computer 03 acquires the two-dimensional code 05 of the encrypted payment result by using the camera 06; and the computer 03 feeds back the two-dimensional code 05 of the encrypted payment result to the server 01.

6. The server 01 decrypts the two-dimensional code 05 of the encrypted payment result to obtain the payment result, and determines, according to the payment result, whether the verification succeeds.

The server 01 receives the two-dimensional code 05 of the encrypted payment result, which is fed back by the computer 03; the server 01 decrypts the two-dimensional code 05 of the encrypted payment result according to the decryption information of the user account A to obtain the payment result; the server 01 detects whether the payment result is that the verification succeeds; and after the server 01 detects that payment result is that the verification succeeds, the server 01 authorizes the computer 03 to execute the payment operation. After the computer 03 receives the authorization by the server 01 on the payment operation, the computer 03 executes an operation corresponding to the payment operation.

The following is apparatus embodiments of the present invention, and for details that are not elaborated therein, reference may be made to corresponding method embodiments.

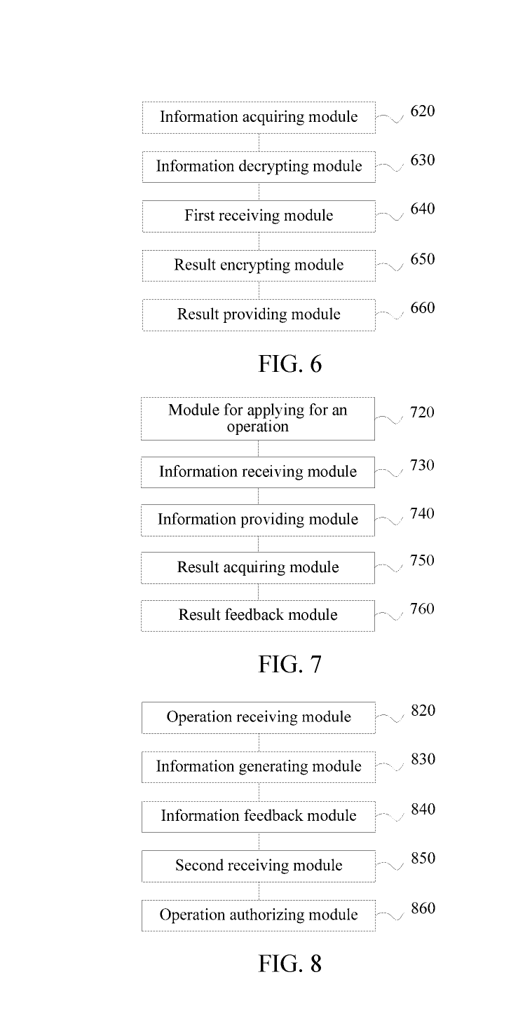

Referring to FIG. 6, FIG. 6 is a schematic structural diagram of a sensitive operation verification apparatus according to an embodiment of the present invention. The sensitive operation verification apparatus may be implemented by software, hardware, or a combination thereof to become all or some of an auxiliary terminal 600. The sensitive operation verification apparatus includes: an information acquiring module 620, an information decrypting module 630, a first receiving module 640, a result encrypting module 650, and a result providing module 660, where

the information acquiring module 620 is configured to acquire encrypted verification information on an operating terminal, where the encrypted verification information is information that is encrypted and used for verifying a sensitive operation of a user account, which is fed back by a server to the operating terminal after the operating terminal applies to the server for the sensitive operation;

the information decrypting module 630 is configured to decrypt the encrypted verification information, which is acquired by the information acquiring module 620, according to decryption information corresponding to the user account to obtain verification information;

the first receiving module 640 is configured to receive a result of verification that is performed on the sensitive operation by a user according to the verification information obtained by the information decrypting module 630;

the result encrypting module 650 is configured to encrypt the verification result, which is obtained by the first receiving module 640, according to encryption information corresponding to the user account to obtain an encrypted verification result; and

the result providing module 660 is configured to provide the encrypted verification result obtained by the result encrypting module 650 to the operating terminal, so that the operating terminal feeds back the encrypted verification result to the server, and after the server detects that the encrypted verification result is that the verification succeeds, the server authorizes the operating terminal to execute the sensitive operation.

In conclusion, with the sensitive operation verification apparatus provided in this embodiment, by acquiring encrypted verification information on an operating terminal; decrypting the encrypted verification information according to decryption information corresponding to a user account to obtain verification information; receiving a result of verification that is performed on the sensitive operation by a user according to the verification information; encrypting the verification result according to encryption information corresponding to the user account to obtain an encrypted verification result; and providing the encrypted verification result to the operating terminal, so that the operating terminal feeds back the encrypted verification result to the server, and after the server detects that the encrypted verification result is that the verification succeeds, the server authorizes the operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

Referring to FIG. 7, FIG. 7 is a schematic structural diagram of a sensitive operation verification apparatus according to an embodiment of the present invention. The sensitive operation verification apparatus may be implemented by software, hardware, or a combination thereof to become all or some of an operating terminal 700. The sensitive operation verification apparatus includes: a module 720 for applying for an operation, an information receiving module 730, an information providing module 740, a result acquiring module 750, and a result feedback module 760, where

the module 720 for applying for an operation is configured to apply to a server for a sensitive operation of a user account;

the information receiving module 730 is configured to receive encrypted verification information fed back by the server and used for verifying the sensitive operation;

the information providing module 740 is configured to provide the encrypted verification information received by the information receiving module 730 to an auxiliary terminal, so that the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain an encrypted verification result, and provides the encrypted verification result to the operating terminal;

the result acquiring module 750 is configured to acquire the encrypted verification result provided by the auxiliary terminal; and

the result feedback module 760 is configured to feed back the encrypted verification result acquired by the result acquiring module 750 to the server, so that after the server detects that the encrypted verification result is that the verification succeeds, the server authorizes the operating terminal to execute the sensitive operation.

In conclusion, with the sensitive operation verification apparatus provided in this embodiment, by applying to a server for a sensitive operation of a user account; receiving encrypted verification information fed back by the server and used for verifying the sensitive operation; providing the encrypted verification information to an auxiliary terminal; acquiring an encrypted verification result provided by the auxiliary terminal; and feeding back the encrypted verification result to the server, so that after the server detects that the encrypted verification result is that the verification succeeds, the server authorizes an operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

Referring to FIG. 8, FIG. 8 is a schematic structural diagram of a sensitive operation verification apparatus according to an embodiment of the present invention. The sensitive operation verification apparatus may be implemented by software, hardware, or a combination thereof to become all or some of a server 800. The sensitive operation verification apparatus includes: an operation receiving module 820, an information generating module 830, an information feedback module 840, a second receiving module 850, and an operation authorizing module 860, where

the operation receiving module 820 is configured to receive a sensitive operation, which an operating terminal applies for, of a user account;

the information generating module 830 is configured to generate encrypted verification information used for verifying the sensitive operation;

the information feedback module 840 is configured to feed back the encrypted verification information used for verifying the sensitive operation to the operating terminal;

the second receiving module 850 is configured to receive an encrypted verification result fed back by the operating terminal, where the encrypted verification result is fed back by the operating terminal to the server after the operating terminal provides the encrypted verification information to an auxiliary terminal, and after the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain the encrypted verification result, and provides the encrypted verification result to the operating terminal; and

the operation authorizing module 860 is configured to: after it is detected that the encrypted verification result received by the second receiving module 850 is that the verification succeeds, authorize the operating terminal to execute the sensitive operation.

In conclusion, with the sensitive operation verification apparatus provided in this embodiment, by receiving a sensitive operation, which an operating terminal applies for, of a user account; generating encrypted verification information used for verifying the sensitive operation; feeding back the encrypted verification information used for verifying the sensitive operation to the operating terminal; receiving an encrypted verification result fed back by the operating terminal; and authorizing, after detecting that the encrypted verification result is that the verification succeeds, the operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

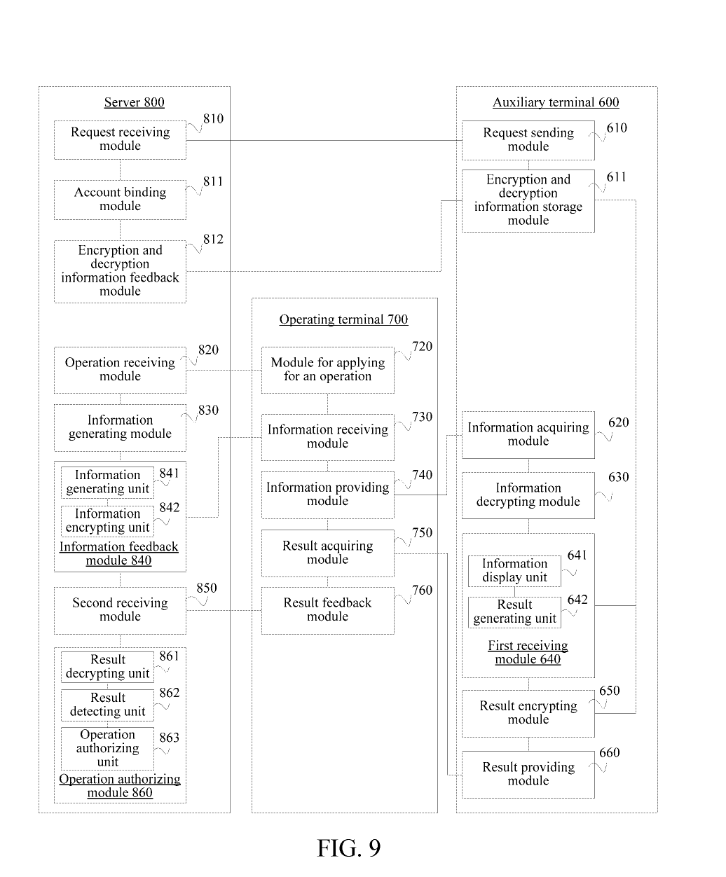

Referring to FIG. 9, FIG. 9 is a schematic structural diagram of a sensitive operation verification system according to an embodiment of the present invention. The sensitive operation verification system includes: the auxiliary terminal 600, the operating terminal 700, and the server 800, where the operating terminal 700 is connected with the server 800 by using a network. Specifically:

The auxiliary terminal 600 includes: an information acquiring module 620, an information decrypting module 630, a first receiving module 640, a result encrypting module 650, and a result providing module 660, where

the information acquiring module 620 is configured to acquire encrypted verification information on the operating terminal, where the encrypted verification information is information that is encrypted and used for verifying a sensitive operation of a user account, which is fed back by the server to the operating terminal after the operating terminal applies to the server for the sensitive operation;

the information decrypting module 630 is configured to decrypt the encrypted verification information, which is acquired by the information acquiring module 620, according to decryption information corresponding to the user account to obtain verification information;

the first receiving module 640 is configured to receive a result of verification that is performed on the sensitive operation by a user according to the verification information obtained by the information decrypting module 630;

the result encrypting module 650 is configured to encrypt the verification result, which is obtained by the first receiving module 640, according to encryption information corresponding to the user account to obtain an encrypted verification result; and

the result providing module 660 is configured to provide the encrypted verification result obtained by the result encrypting module 650 to the operating terminal, so that the operating terminal feeds back the encrypted verification result to the server, and after the server detects that the encrypted verification result is that the verification succeeds, the server authorizes the operating terminal to execute the sensitive operation.

Further, the information acquiring module 620 includes: a first acquiring unit, a second acquiring unit, a third acquiring unit, or a fourth acquiring unit, where

the first acquiring unit is configured to: if the encrypted verification information is in a graphic code form, acquire the encrypted verification information in a graphic code form from the operating terminal by using a camera;

the second acquiring unit is configured to: if the encrypted verification information is in a sound wave form, acquire the encrypted verification information in a sound wave form from the operating terminal by using a microphone;

the third acquiring unit is configured to: if the encrypted verification information is in a character form, acquire the encrypted verification information in a character form from the operating terminal by using a data line or Bluetooth or Infrared or a wireless network; and

the fourth acquiring unit is configured to: if the encrypted verification information is in a light wave form, acquire the encrypted verification information in a light wave form from the operating terminal by using a light sensing component.

Further, the result providing module 660 includes: a first providing unit, a second providing unit, a third providing unit, or a fourth providing unit, where

the first providing unit is configured to provide the encrypted verification result in a graphic code form to the operating terminal;

the second providing unit is configured to provide the encrypted verification result in a sound wave form to the operating terminal;

the third providing unit is configured to provide the encrypted verification result in a character form to the operating terminal; and

the fourth providing unit is configured to provide the encrypted verification result in a light wave form to the operating terminal.

Further, the first receiving module 640 includes: an information display unit 641 and a result generating unit 642, where

the information display unit 641 is configured to display the verification information; and

the result generating unit 642 is configured to receive an instruction indicating that the verification succeeds or an instruction indicating that the verification does not succeed, which is triggered by the user after verifying the sensitive operation according to the verification information displayed by the information display unit 641, and generate a corresponding verification result.

Further, the auxiliary terminal 600 further includes: a request sending module 610 and an encryption and decryption information storage module 611, where

the request sending module 610 is configured to send a binding request to the server, where the binding request is used for requesting binding to the user account; and

the encryption and decryption information storage module 611 is configured to receive and store the decryption information and the encryption information that are fed back by the server after the binding succeeds and correspond to the user account.

Further, the auxiliary terminal 600 further includes: a first sending module, configured to send a hardware capability configuration of the auxiliary terminal to the server in advance, so that the server generates, according to the hardware capability configuration of the auxiliary terminal, the encrypted verification information in a form supported by hardware of the auxiliary terminal, where the hardware capability configuration includes at least one of a camera, a microphone, a data line interface, a Bluetooth module, a WIFI module, and a light sensing component.

Further, the auxiliary terminal 600 further includes: a third receiving module, configured to receive a hardware capability configuration sent by the operating terminal, where the hardware capability configuration includes at least one of a camera, a microphone, a data line interface, a Bluetooth module, a WIFI module, and a light sensing component, and

the result encrypting module 650 is further configured to generate, according to the hardware capability configuration of the operating terminal, the encrypted verification result in a form supported by hardware of the operating terminal.

The operating terminal 700 includes: a module 720 for applying for an operation, an information receiving module 730, an information providing module 740, a result acquiring module 750, and a result feedback module 760, where

the module 720 for applying for an operation is configured to apply to the server for a sensitive operation of a user account;

the information receiving module 730 is configured to receive encrypted verification information fed back by the server and used for verifying the sensitive operation;

the information providing module 740 is configured to provide the encrypted verification information received by the information receiving module 730 to the auxiliary terminal, so that the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain an encrypted verification result, and provides the encrypted verification result to the operating terminal;

the result acquiring module 750 is configured to acquire the encrypted verification result provided by the auxiliary terminal; and

the result feedback module 760 is configured to feed back the encrypted verification result acquired by the result acquiring module 750 to the server, so that after the server detects that the encrypted verification result is that the verification succeeds, the server authorizes the operating terminal to execute the sensitive operation.

Further, the information providing module 740 includes: a fifth providing unit, a sixth providing unit, a seventh providing unit, or an eighth providing unit, where

the fifth providing unit is configured to provide the encrypted verification information in a graphic code form to the auxiliary terminal;

the sixth providing unit is configured to provide the encrypted verification information in a sound wave form to the auxiliary terminal;

the seventh providing unit is configured to provide the encrypted verification information in a character form to the auxiliary terminal; and

the eighth providing unit is configured to provide the encrypted verification information in a light wave form to the auxiliary terminal.

Further, the result acquiring module 750 includes: a fifth acquiring unit, a sixth acquiring unit, a seventh acquiring unit, or an eighth acquiring unit, where

the fifth acquiring unit is configured to: if the encrypted verification result is in a graphic code form, acquire the encrypted verification result in a graphic code form from the auxiliary terminal by using a camera;

the sixth acquiring unit is configured to: if the encrypted verification result is in a sound wave form, acquire the encrypted verification result in a sound wave form from the auxiliary terminal by using a microphone;

the seventh acquiring unit is configured to: if the encrypted verification result is in a character form, acquire the encrypted verification result in a character form from the auxiliary terminal by using a data line or Bluetooth or Infrared or a wireless network; and

the eighth acquiring unit is configured to: if the encrypted verification result is in a light wave form, acquire the encrypted verification result in a light wave form from the auxiliary terminal by using a light sensing component.

The information receiving module 730 is further configured to receive the encrypted verification information in a form supported by hardware of the auxiliary terminal, which is generated by the server according to a hardware capability configuration of the auxiliary terminal, where the hardware capability configuration includes at least one of a camera, a microphone, a data line interface, a Bluetooth module, a WIFI module, and a light sensing component, and the hardware capability configuration is sent by the auxiliary terminal to the server in advance.

The operating terminal 700 further includes: a second sending module, configured to send a hardware capability configuration of the operating terminal to the auxiliary terminal, so that the auxiliary terminal generates, according to the hardware capability configuration of the operating terminal, the encrypted verification result in a form supported by hardware of the operating terminal, where the hardware capability configuration includes at least one of a camera, a microphone, a data line interface, a Bluetooth module, a WIFI module, and a light sensing component.

The server 800 includes: an operation receiving module 820, an information generating module 830, an information feedback module 840, a second receiving module 850, and an operation authorizing module 860, where

the operation receiving module 820 is configured to receive a sensitive operation, which the operating terminal applies for, of a user account;

the information generating module 830 is configured to generate encrypted verification information used for verifying the sensitive operation;

the information feedback module 840 is configured to feed back the encrypted verification information used for verifying the sensitive operation to the operating terminal;

the second receiving module 850 is configured to receive an encrypted verification result fed back by the operating terminal, where the encrypted verification result is fed back by the operating terminal to the server after the operating terminal provides the encrypted verification information to the auxiliary terminal, and after the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain the encrypted verification result, and provides the encrypted verification result to the operating terminal; and

the operation authorizing module 860 is configured to: after it is detected that the encrypted verification result received by the second receiving module 850 is that the verification succeeds, authorize the operating terminal to execute the sensitive operation.

Further, the server 800 further includes: a request receiving module 810, an account binding module 811, and an encryption and decryption information feedback module 812, where

the request receiving module 810 is configured to receive a binding request sent by the auxiliary terminal, where the binding request is used for requesting binding to the user account;

the account binding module 811 is configured to bind the auxiliary terminal to the user account according to the binding request received by the request receiving module 810; and

the encryption and decryption information feedback module 812 is configured to feed back the decryption information and the encryption information that correspond to the user account to the auxiliary terminal after the account binding module 811 successfully binds the auxiliary terminal to the user account.

Further, the information feedback module 840 includes: an information generating unit 841 and an information encrypting unit 842, where

the information generating unit 841 is configured to generate verification information according to the sensitive operation, where the verification information includes the user account, an identifier of the verification information, and operation content corresponding to the sensitive operation; and

the information encrypting unit 842 is configured to encrypt the verification information, which is generated by the information generating unit 841, according to the encryption information corresponding to the user account to obtain the encrypted verification information.

The server 800 further includes:

a fourth receiving module, configured to receive a hardware capability configuration of the auxiliary terminal sent by the auxiliary terminal, where the hardware capability configuration includes at least one of a camera, a microphone, a data line interface, a Bluetooth module, a WIFI module, and a light sensing component, and

the information encrypting unit 842 is further configured to generate, according to the hardware capability configuration of the auxiliary terminal when encrypting the verification information according to the encryption information corresponding to the user account, the encrypted verification information in a form supported by hardware of the auxiliary terminal.

Further, the operation authorizing module 860 includes: a result decrypting unit 861, a result detecting unit 862, and an operation authorizing unit 863, where

the result decrypting unit 861 is configured to decrypt the encrypted verification result according to the decryption information corresponding to the user account to obtain the verification result;

the result detecting unit 862 is configured to detect whether the verification result obtained by the result decrypting unit 861 is that the verification succeeds; and

the operation authorizing unit 863 is configured to: if a result of the detection detected by the result detecting unit 862 is that the verification succeeds, authorize the operating terminal to execute the sensitive operation.

In conclusion, with the sensitive operation verification system provided in this embodiment, by acquiring encrypted verification information on an operating terminal; decrypting the encrypted verification information according to decryption information corresponding to a user account to obtain verification information; receiving a result of verification that is performed on the sensitive operation by a user according to the verification information; encrypting the verification result according to encryption information corresponding to the user account to obtain an encrypted verification result; and providing the encrypted verification result to the operating terminal, so that the operating terminal feeds back the encrypted verification result to the server, and after the server detects that the encrypted verification result is that the verification succeeds, the server authorizes the operating terminal to execute the sensitive operation, the present disclosure solves a problem that an auxiliary terminal needs to communicate with a server to receive a verification password sent by the server, and implements that the auxiliary terminal can receive encrypted verification information without communicating with the server.

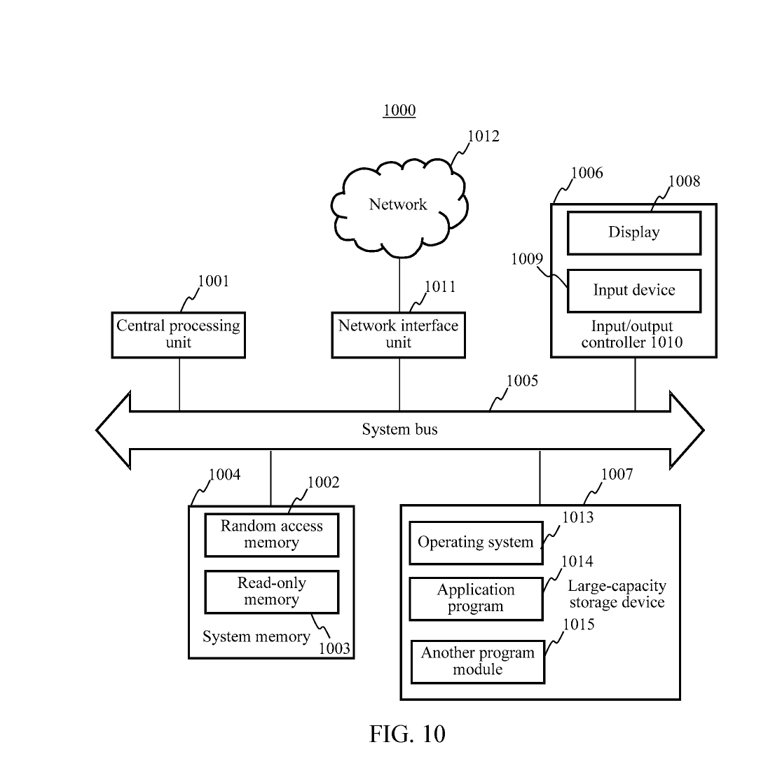

Referring to FIG. 10, FIG. 10 is a schematic structural diagram of a server according to an embodiment of the present invention. The server is configured to implement the sensitive operation verification method provided in the foregoing embodiments. Specifically:

The server 1000 includes a central processing unit (CPU) 1001, a system memory 1004 including a random access memory (RAM) 1002 and a read-only memory (ROM) 1003, and a system bus 1005 connecting the system memory 1004 and the CPU 1001. The server 1000 further includes a basic input/output system (I/O system) 1006 that helps information transmission between components in a computer, and a large-capacity storage device 1007 for storing an operation system 1013, an application program 1014, and another program module 1015.

The basic I/O system 1006 includes a display 1008 for displaying information and an input device 1009, such as a mouse or a keyboard, for a user to input information. The display 1008 and the input device 1009 both connect to the CPU 1001 by using the input/output controller 1010 connected to the system bus 1005. The basic I/O system 1006 may further include an input/output controller 1010 to receive and process input from multiple other devices such as a keyboard, a mouse, and an electronic stylus. Similarly, the input/output controller 1010 further provides output to a screen, a printer, or an output device of another type.

The large-capacity storage device 1007 is connected to the CPU 1001 by using a large-capacity storage controller (not shown) connected to the system bus 1005. The large-capacity storage device 1007 and an associated computer readable medium provide non-volatile storage to a client device. That is, the large-capacity storage device 1007 may include a computer readable medium (not shown) such as a hard disk or a CD-ROM drive.

Without loss of generality, the computer readable medium may include a computer storage medium and a communications medium. The computer storage medium includes a volatile, non-volatile, movable, or unmovable medium that is implemented by using any method or technology, and configured to store information such as a computer readable instruction, a data structure, a program module, or other data. The computer storage medium includes a RAM, a ROM, an EPROM, an EEPROM, a flash memory, or other solid storage technologies, a CD-ROM, a DVD or other optical storage, a cassette, a magnetic tape, a disk storage or other magnetic storage devices. Certainly, a person skilled in the art may know that the computer storage medium is not limited to the foregoing. The system memory 1004 and the large-capacity storage device 1007 may be collectively referred to as a memory.

According to the embodiments of the present invention, the server 1000 may also run by connecting to a remote computer in a network by using a network such as the Internet. That is, the server 1000 may be connected to a network 1012 by using a network interface unit 1011 of the system bus 1005, or be connected to a network of another type or a remote computer system (not shown) by using the network interface unit 1011.

The memory further includes one or more programs. The one or more programs are stored in the memory and configured to be executed by one or more CPUs 1001. The one or more programs contain instructions used for implementing the sensitive operation verification method provided in the embodiments show in FIG. 4 and FIG. 5A.

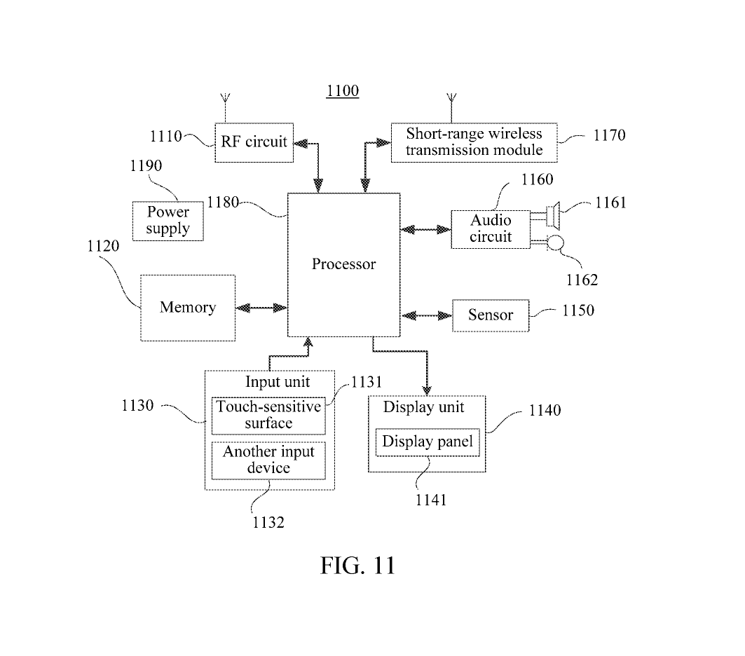

Referring to FIG. 11, FIG. 11 is a schematic structural diagram of a terminal according to an embodiment of the present invention. The terminal may be an auxiliary terminal, and may also be an operating terminal. The auxiliary terminal and the operating terminal may include more components or fewer components than those shown in the figure, or some components may be combined, or a different component deployment may be used. The terminal 1100 is configured to implement the sensitive operation verification method provided in the foregoing embodiments. Specifically:

The terminal 1100 may include components such as a radio frequency (RF) circuit 1110, a memory 1120 including one or more computer readable storage media, an input unit 1130, a display unit 1140, a sensor 1150, an audio circuit 1160, a short-range wireless transmission module 1170, a processor 1180 including one or more processing cores, and a power supply 1190. A person skilled in the art may understand that the structure of the terminal shown in FIG. 11 does not constitute a limitation to the terminal, and the terminal may include more components or fewer components than those shown in the figure, or some components may be combined, or a different component deployment may be used.

The RF circuit 1110 may be configured to receive and send signals during an information receiving and sending process or a call process. Particularly, the RF circuit 1110 receives downlink information from a base station, then delivers the downlink information to the processor 1180 for processing, and sends related uplink data to the base station. Generally, the RF circuit 1110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 1110 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like. The memory 1120 may be configured to store a software program and module. For example, the memory 1120 may be configured to store a preset time list, may be further configured to store a software program for collecting a voice signal, a software program for identifying a keyword, a software program for implementing continuous voice recognition, and a software program for setting a reminder, and may be further configured to store a binding relationship between a wireless access point and a user account. The processor 1180 runs the software program and module stored in the memory 1120, to implement various functional applications and data processing, for example, a function of “decrypting encrypted verification information according to decryption information corresponding to a user account to obtain verification information” and a function of “encrypting a verification result according to encryption information corresponding to a user account to obtain an encrypted verification result” in the embodiments of the present invention. The memory 1120 may mainly include a program storage area and a data storage area. The program storage area may store an operating system, an application program required by at least one function (such as a sound playback function and an image display function), and the like. The data storage area may store data (such as audio data and an address book) created according to use of the terminal 1100, and the like. In addition, the memory 1120 may include a high speed random access memory, and may also include a non-volatile memory, such as at least one magnetic disk storage device, a flash memory, or another volatile solid storage device. Accordingly, the memory 1120 may further include a memory controller, so that the processor 1180 and the input unit 1130 access the memory 1120.

The input unit 1130 may be configured to receive input digit or character information, and generate keyboard, mouse, joystick, optical, or track ball signal input related to the user setting and function control. Specifically, the input unit 1130 may include a touch-sensitive surface 1131 and another input device 1132. The touch-sensitive surface 1131 may also be referred to as a touch screen or a touch panel, and may collect a touch operation of a user on or near the touch-sensitive surface (such as an operation of a user on or near the touch-sensitive surface 1131 by using any suitable object or attachment, such as a finger or a touch pen), and drive a corresponding connection apparatus according to a preset program. Optionally, the touch-sensitive surface 1131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 1180. Moreover, the touch controller can receive and execute a command sent from the processor 1180. In addition, the touch-sensitive surface 1131 may be implemented by using various types, such as a resistive type, a capacitance type, an Infrared type, and a surface sound wave type. In addition to the touch-sensitive surface 1131, the input unit 1130 may include a touch-sensitive surface 1132 and another input device 132. Specifically, the another input device 1132 may include, but is not limited to, one or more of a physical keyboard, a functional key (such as a volume control key or a switch key), a track ball, a mouse, and a joystick.

The display unit 1140 may be configured to display information input by the user or information provided for the user, and various graphical user ports of the terminal 1100. The graphical user ports may be formed by a graph, a text, an icon, a video, and any combination thereof. The display unit 1140 may include a display panel 1141. Optionally, the display panel 1141 may be configured by using a liquid crystal display (LCD), an organic light-emitting diode (OLED), or the like. Further, the touch-sensitive surface 1131 may cover the display panel 1141. After detecting a touch operation on or near the touch-sensitive surface 1131, the touch-sensitive surface 1131 transfers the touch operation to the processor 1180, so as to determine a type of a touch event. Then, the processor 1180 provides corresponding visual output on the display panel 1141 according to the type of the touch event. Although, in FIG. 11, the touch-sensitive surface 1131 and the display panel 1141 are used as two separate parts to implement input and output functions, in some embodiments, the touch-sensitive surface 1131 and the display panel 1141 may be integrated to implement the input and output functions.

The terminal 1100 may further include at least one sensor 1150, such as an optical sensor, a motion sensor, and other sensors. Specifically, the optical sensor may include an ambient light sensor and a proximity sensor. The ambient light sensor may adjust luminance of the display panel 1141 according to brightness of the ambient light. The proximity sensor may switch off the display panel 1141 and/or backlight when the terminal 1100 is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone gesture (such as switchover between horizontal and vertical screens, a related game, and gesture calibration of a magnetometer), a related function of vibration identification (such as a pedometer and a knock). Other sensor, such as a gyroscope, a barometer, a hygrometer, a thermometer, and an Infrared sensor, which may be configured in the terminal 1100 are not further described herein.

The audio circuit 1160, a loudspeaker 1161, and a microphone 1162 may provide audio interfaces between the user and the terminal 1100. The audio circuit 1160 may transmit, to the loudspeaker 1161, a received electric signal converted from received audio data. The loudspeaker 1161 converts the electric signal into a sound signal for output. On the other hand, the microphone 1162 converts a collected sound signal into an electric signal. The audio circuit 1160 receives the electric signal and converts the electric signal into audio data, and outputs the audio data to the processor 1180 for processing. Then, the processor 1180 sends the audio data to, for example, another terminal by using the RF circuit 1110, or outputs the audio data to the memory 1120 for further processing. The audio circuit 1160 may further include an earplug jack, so as to provide communication between a peripheral earphone and the terminal 1100.

The short-range wireless transmission module 1170 may be a WIFI module, a Bluetooth module, or the like. The terminal 1100 may help, by using the short-range wireless transmission module 1170, a user to receive and send e-mails, browse a webpage, access streaming media, and so on, which provides wireless broadband Internet access for the user. Although FIG. 11 shows the short-range wireless transmission module 1170, it may be understood that, the short-range wireless transmission module is not a necessary constitution of the terminal 1100, and when required, the short-range wireless transmission module may be omitted as long as the scope of the essence of the present disclosure is not changed.

The processor 1180 is a control center of the terminal 1100, and is connected to various parts of the terminal by using various interfaces and lines. By running or executing the software program and/or module stored in the memory 1120, and invoking data stored in the memory 1120, the processor 1180 performs various functions and data processing of the terminal 1100, thereby performing overall monitoring on the terminal 1100. Optionally, the processor 1180 may include one or more processing cores. Optionally, the processor 1180 may integrate an application processor and a modem. The application processor mainly processes an operating system, a user interface, an application program, and the like. The modem mainly processes wireless communication. It may be understood that, the foregoing modem may also not be integrated into the processor 1180.

The terminal 1100 further includes the power supply 1190 (such as a battery) for supplying power to the components. Preferably, the power supply may logically connect to the processor 1180 by using a power supply management system, thereby implementing functions, such as charging, discharging, and power consumption management, by using the power supply management system. The power supply 1190 may further include any component, such as one or more direct current or alternate current power supplies, a re-charging system, a power supply fault detection circuit, a power supply converter or an inverter, and a power supply state indicator.

Although not shown in the figure, the terminal 1100 may further include a camera, a Bluetooth module, and the like, which are not further described herein.

The terminal 1100 further includes a memory and one or more programs. The one or more programs are stored in the memory and configured to be executed by one or more processors to implement the sensitive operation verification method according to the embodiment of the present invention shown in FIG. 1, or FIG. 2, or FIG. 5A.

It should be supplemented that, in another embodiment, the terminal may include more components or fewer components than those shown in FIG. 11, or some components may be combined, or a different component deployment is used, to implement all or some of functions.

The sequence numbers of the foregoing embodiments of the present invention are merely for description, and do not imply the preference among the embodiments.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a ROM, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

1. A sensitive operation verification method, applied to an auxiliary terminal, the method comprising:
acquiring encrypted verification information on an operating terminal, the encrypted verification information being information that is encrypted and used for verifying a sensitive operation of a user account, which is fed back by a server to the operating terminal after the operating terminal applies to the server for the sensitive operation;
decrypting the encrypted verification information according to decryption information corresponding to the user account to obtain verification information;
receiving a result of verification that is performed on the sensitive operation by a user according to the verification information;
encrypting the verification result according to encryption information corresponding to the user account to obtain an encrypted verification result; and
providing the encrypted verification result to the operating terminal, so that the operating terminal feeds back the encrypted verification result to the server, and after the server detects that the encrypted verification result is that the verification succeeds, the server authorizes the operating terminal to execute the sensitive operation.

2. The method according to claim 1, wherein the acquiring encrypted verification information on an operating terminal comprises:
acquiring, if the encrypted verification information is in a graphic code form, the encrypted verification information in a graphic code form from the operating terminal by using a camera; or
acquiring, if the encrypted verification information is in a sound wave form, the encrypted verification information in a sound wave form from the operating terminal by using a microphone; or
acquiring, if the encrypted verification information is in a character form, the encrypted verification information in a character form from the operating terminal by using a data line or Bluetooth or Infrared or a wireless network; or
acquiring, if the encrypted verification information is in a light wave form, the encrypted verification information in a light wave form from the operating terminal by using a light sensing component.

3. The method according to claim 1, wherein the providing the encrypted verification result to the operating terminal comprises:
providing the encrypted verification result in a graphic code form to the operating terminal; or
providing the encrypted verification result in a sound wave form to the operating terminal; or
providing the encrypted verification result in a character form to the operating terminal; or
providing the encrypted verification result in a light wave form to the operating terminal.

4. The method according to claim 1, wherein the receiving a result of verification that is performed on the sensitive operation by a user according to the verification information comprises:
displaying the verification information; and
receiving an instruction indicating that the verification succeeds or an instruction indicating that the verification does not succeed, which is triggered by the user after verifying the sensitive operation according to the verification information, and generating a corresponding verification result.

5. The method according to claim 1, wherein before the decrypting the encrypted verification information according to decryption information corresponding to the user account to obtain verification information, the method further comprises:
sending a binding request to the server, wherein the binding request is used for requesting binding to the user account; and
receiving and storing the decryption information and the encryption information that are fed back by the server after the binding succeeds and correspond to the user account.

6. The method according to claim 2, wherein before the acquiring encrypted verification information on an operating terminal, the method further comprises:
sending a hardware capability configuration of the auxiliary terminal to the server in advance, so that the server generates, according to the hardware capability configuration of the auxiliary terminal, the encrypted verification information in a form supported by hardware of the auxiliary terminal, wherein the hardware capability configuration comprises at least one of a camera, a microphone, a data line interface, a Bluetooth module, a WIFI module, and a light sensing component.

7. The method according to claim 3, wherein before the providing the encrypted verification result to the operating terminal, the method further comprises:
receiving a hardware capability configuration sent by the operating terminal, wherein the hardware capability configuration comprises at least one of a camera, a microphone, a data line interface, a Bluetooth module, a WIFI module, and a light sensing component; and
generating, according to the hardware capability configuration of the operating terminal, the encrypted verification result in a form supported by hardware of the operating terminal.

8. A sensitive operation verification method, applied to an operating terminal, the method comprising:
applying to a server for a sensitive operation of a user account;
receiving encrypted verification information fed back by the server and used for verifying the sensitive operation;
providing the encrypted verification information to an auxiliary terminal, so that the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain an encrypted verification result, and provides the encrypted verification result to the operating terminal;
acquiring the encrypted verification result provided by the auxiliary terminal; and
feeding back the encrypted verification result to the server, so that after the server detects that the encrypted verification result is that the verification succeeds, the server authorizes the operating terminal to execute the sensitive operation.

9. The method according to claim 8, wherein the providing the encrypted verification information to an auxiliary terminal comprises:
providing the encrypted verification information in a graphic code form to the auxiliary terminal; or
providing the encrypted verification information in a sound wave form to the auxiliary terminal; or
providing the encrypted verification information in a character form to the auxiliary terminal; or
providing the encrypted verification information in a light wave form to the auxiliary terminal.

10. The method according to claim 8, wherein the acquiring the encrypted verification result provided by the auxiliary terminal comprises:
acquiring, if the encrypted verification result is in a graphic code form, the encrypted verification result in a graphic code form from the auxiliary terminal by using a camera; or
acquiring, if the encrypted verification result is in a sound wave form, the encrypted verification result in a sound wave form from the auxiliary terminal by using a microphone; or
acquiring, if the encrypted verification result is in a character form, the encrypted verification result in a character form from the auxiliary terminal by using a data line or Bluetooth or Infrared or a wireless network; or
acquiring, if the encrypted verification result is in a light wave form, the encrypted verification result in a light wave form from the auxiliary terminal by using a light sensing component.

11. The method according to claim 8, wherein the receiving encrypted verification information fed back by the server and used for verifying the sensitive operation comprises:
receiving the encrypted verification information in a form supported by hardware of the auxiliary terminal, which is generated by the server according to a hardware capability configuration of the auxiliary terminal, wherein the hardware capability configuration comprises at least one of a camera, a microphone, a data line interface, a Bluetooth module, a WIFI module, and a light sensing component, and the hardware capability configuration is sent by the auxiliary terminal to the server in advance.

12. The method according to claim 9, wherein before the acquiring the encrypted verification result provided by the auxiliary terminal, the method further comprises:
sending a hardware capability configuration of the operating terminal to the auxiliary terminal, so that the auxiliary terminal generates, according to the hardware capability configuration of the operating terminal, the encrypted verification result in a form supported by hardware of the operating terminal, wherein the hardware capability configuration comprises at least one of a camera, a microphone, a data line interface, a Bluetooth module, a WIFI module, and a light sensing component.

13. A sensitive operation verification method, applied to a server, the method comprising:
receiving a sensitive operation, which an operating terminal applies for, of a user account;
generating encrypted verification information used for verifying the sensitive operation;
feeding back the encrypted verification information used for verifying the sensitive operation to the operating terminal;
receiving an encrypted verification result fed back by the operating terminal, the encrypted verification result being fed back by the operating terminal to the server after the operating terminal provides the encrypted verification information to an auxiliary terminal, and after the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain the encrypted verification result, and provides the encrypted verification result to the operating terminal; and
authorizing, after detecting that the encrypted verification result is that the verification succeeds, the operating terminal to execute the sensitive operation.

14. The method according to claim 13, wherein before the receiving an encrypted verification result fed back by the operating terminal, the method further comprises:
receiving a binding request sent by the auxiliary terminal, wherein the binding request is used for requesting binding to the user account;
binding the auxiliary terminal to the user account; and
feeding back the decryption information and the encryption information that correspond to the user account to the auxiliary terminal after the binding succeeds.

15. The method according to claim 13, wherein the generating encrypted verification information used for verifying the sensitive operation comprises:
generating verification information according to the sensitive operation, wherein the verification information comprises the user account, an identifier of the verification information, and operation content corresponding to the sensitive operation; and
encrypting the verification information according to the encryption information corresponding to the user account to obtain the encrypted verification information.

16. The method according to claim 15, wherein before the encrypting the verification information according to the encryption information corresponding to the user account to obtain the encrypted verification information, the method further comprises:
receiving a hardware capability configuration of the auxiliary terminal sent by the auxiliary terminal, wherein the hardware capability configuration comprises at least one of a camera, a microphone, a data line interface, a Bluetooth module, a WIFI module, and a light sensing component; and
the encrypting the verification information according to the encryption information corresponding to the user account to obtain the encrypted verification information comprises:
generating, according to the hardware capability configuration of the auxiliary terminal when encrypting the verification information according to the encryption information corresponding to the user account, the encrypted verification information in a form supported by hardware of the auxiliary terminal.

17. The method according to claim 13, wherein the authorizing, after detecting that the encrypted verification result is that the verification succeeds, the operating terminal to execute the sensitive operation comprises:
decrypting the encrypted verification result according to the decryption information corresponding to the user account to obtain the verification result;
detecting whether the verification result is that the verification succeeds; and
authorizing, if a result of the detection is that the verification succeeds, the operating terminal to execute the sensitive operation.

18. A sensitive operation verification apparatus, applied to an auxiliary terminal, the apparatus comprising:
an information acquiring module, configured to acquire encrypted verification information on an operating terminal, the encrypted verification information being information that is encrypted and used for verifying a sensitive operation of a user account, which is fed back by a server to the operating terminal after the operating terminal applies to the server for the sensitive operation;
an information decrypting module, configured to decrypt the encrypted verification information according to decryption information corresponding to the user account to obtain verification information;
a first receiving module, configured to receive a result of verification that is performed on the sensitive operation by a user according to the verification information;
a result encrypting module, configured to encrypt the verification result according to encryption information corresponding to the user account to obtain an encrypted verification result; and
a result providing module, configured to provide the encrypted verification result to the operating terminal, so that the operating terminal feeds back the encrypted verification result to the server, and after the server detects that the encrypted verification result is that the verification succeeds, the server authorizes the operating terminal to execute the sensitive operation.

19. A sensitive operation verification apparatus, applied to an operating terminal, the apparatus comprising:
a module for applying for an operation, configured to apply to a server for a sensitive operation of a user account;
an information receiving module, configured to receive encrypted verification information fed back by the server and used for verifying the sensitive operation;
an information providing module, configured to provide the encrypted verification information to an auxiliary terminal, so that the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain an encrypted verification result, and provides the encrypted verification result to the operating terminal;
a result acquiring module, configured to acquire the encrypted verification result provided by the auxiliary terminal; and
a result feedback module, configured to feed back the encrypted verification result to the server, so that after the server detects that the encrypted verification result is that the verification succeeds, the server authorizes the operating terminal to execute the sensitive operation.

20. A sensitive operation verification apparatus, applied to a server, the apparatus comprising:
an operation receiving module, configured to receive a sensitive operation, which an operating terminal applies for, of a user account;
an information generating module, configured to generate encrypted verification information used for verifying the sensitive operation;
an information feedback module, configured to feed back the encrypted verification information used for verifying the sensitive operation to the operating terminal;
a second receiving module, configured to receive an encrypted verification result fed back by the operating terminal, the encrypted verification result being fed back by the operating terminal to the server after the operating terminal provides the encrypted verification information to an auxiliary terminal, and after the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain the encrypted verification result, and provides the encrypted verification result to the operating terminal; and
an operation authorizing module, configured to: after it is detected that the encrypted verification result is that the verification succeeds, authorize the operating terminal to execute the sensitive operation.

21. A sensitive operation verification system, comprising: an auxiliary terminal, an operating terminal, and a server, wherein
the auxiliary terminal comprises a sensitive operation verification apparatus comprising:
an information acquiring module, configured to acquire encrypted verification information on an operating terminal, the encrypted verification information being information that is encrypted and used for verifying a sensitive operation of a user account, which is fed back by a server to the operating terminal after the operating terminal applies to the server for the sensitive operation;
an information decrypting module, configured to decrypt the encrypted verification information according to decryption information corresponding to the user account to obtain verification information;
a first receiving module, configured to receive a result of verification that is performed on the sensitive operation by a user according to the verification information;
a result encrypting module, configured to encrypt the verification result according to encryption information corresponding to the user account to obtain an encrypted verification result; and
a result providing module, configured to provide the encrypted verification result to the operating terminal, so that the operating terminal feeds back the encrypted verification result to the server, and after the server detects that the encrypted verification result is that the verification succeeds, the server authorizes the operating terminal to execute the sensitive operation;
the operating terminal comprises a sensitive operation verification apparatus comprising:
a module for applying for an operation, configured to apply to a server for a sensitive operation of a user account;
an information receiving module, configured to receive encrypted verification information fed back by the server and used for verifying the sensitive operation;
an information providing module, configured to provide the encrypted verification information to an auxiliary terminal, so that the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain an encrypted verification result, and provides the encrypted verification result to the operating terminal;
a result acquiring module, configured to acquire the encrypted verification result provided by the auxiliary terminal; and
a result feedback module, configured to feed back the encrypted verification result to the server, so that after the server detects that the encrypted verification result is that the verification succeeds, the server authorizes the operating terminal to execute the sensitive operation; and
the server comprises a sensitive operation verification apparatus comprising:
an operation receiving module, configured to receive a sensitive operation, which an operating terminal applies for, of a user account;
an information generating module, configured to generate encrypted verification information used for verifying the sensitive operation;
an information feedback module, configured to feed back the encrypted verification information used for verifying the sensitive operation to the operating terminal;
a second receiving module, configured to receive an encrypted verification result fed back by the operating terminal, the encrypted verification result being fed back by the operating terminal to the server after the operating terminal provides the encrypted verification information to an auxiliary terminal, and after the auxiliary terminal decrypts the encrypted verification information according to decryption information corresponding to the user account to obtain verification information, receives a result of verification that is performed on the sensitive operation by a user according to the verification information, encrypts the verification result according to encryption information corresponding to the user account to obtain the encrypted verification result, and provides the encrypted verification result to the operating terminal; and
an operation authorizing module, configured to: after it is detected that the encrypted verification result is that the verification succeeds, authorize the operating terminal to execute the sensitive operation.

22. A non-transitory computer storage medium storing computer-executable instructions which, when executed on a computer or a processor, cause the computer or processor to carry out the method according to claim 1.

23. A non-transitory computer storage medium storing computer-executable instructions which, when executed on a computer or a processor, cause the computer or processor to carry out the method according to claim 8.

24. A non-transitory computer storage medium storing computer-executable instructions which, when executed on a computer or a processor, cause the computer or processor to carry out the method according to claim 13.
